(19) United States
(12) Patent Application Publication
(10) Pub. No.: US 2024/0202256 A1
(43) Pub. Date: Jun. 20, 2024

(54) SELLER RISK DETECTION BY PRODUCT COMMUNITY AND SUPPLY CHAIN MODELLING WITH ONLY TRANSACTION RECORDS

(71) Applicant: PAYPAL, INC., San Jose, CA (US)

(72) Inventors: Zhe Chen, Singapore (SG); Jiyi Zhang, Singapore (SG); Ting Lin, Singapore (SG); Quan Jin Ferdinand Tang, Singapore (SG)

(21) Appl. No.: 18/082,870

(22) Filed: Dec. 16, 2022

(51) Int. Cl. G06F 16/953; G06F 16/906

(52) U.S. Cl. CPC G06F 16/953; G06F 16/906

(57) ABSTRACT

A method includes defining a first data vector of a first entity based on a set of data records associated with representative activities of the first entity, wherein the set of data records includes product data associated with the first entity, and an activities relationship between the first entity and a plurality of second entities. The method further includes defining a second data vector of the first entity based on supply chain topological connections between the second entities and the first entity, utilizing, a clustering space machine learning model to generate an entity vector representing the first entity based on the first data vector and the second data vector, and utilizing a classification machine learning model to generate an entity-specific classification of the first entity based on the entity vector.

### TECHNICAL FIELD

This disclosure generally relates to improving predictive results of a characteristic of an entity based on data records using multi-label classification and generating training data based on joint learning.

### BACKGROUND

Electronic platforms used for transactive activities may include data related to past activities of an entity. In some instances, entities on the electronic platforms may be fraudulent actors or may exhibit characteristics that are detrimental to the electronic platform.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the present disclosure.

FIG. 1 is a diagrammatic view of a networked environment for generating an entity-specific classification of an entity, according to embodiments of the present disclosure.

FIG. 2 is a flow chart illustrating an example method for generating an entity-specific classification of an entity, according to embodiments of the present disclosure.

FIG. 3 is a merchant item description according to embodiments of the present disclosure.

FIG. 4 is a flow chart illustrating an example method for tokenization, aggregation, ranking and vectorization of words in a merchant's item description, according to embodiments of the present disclosure.

FIG. 5 is a supply chain graph representing a supply chain of two merchants, according to embodiments of the present disclosure.

FIG. 6 is a diagrammatic view of a machine learning architecture for generating an entity-specific classification of an entity, according to embodiments of the present disclosure

FIG. 7 is a block diagram of an example computing system.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

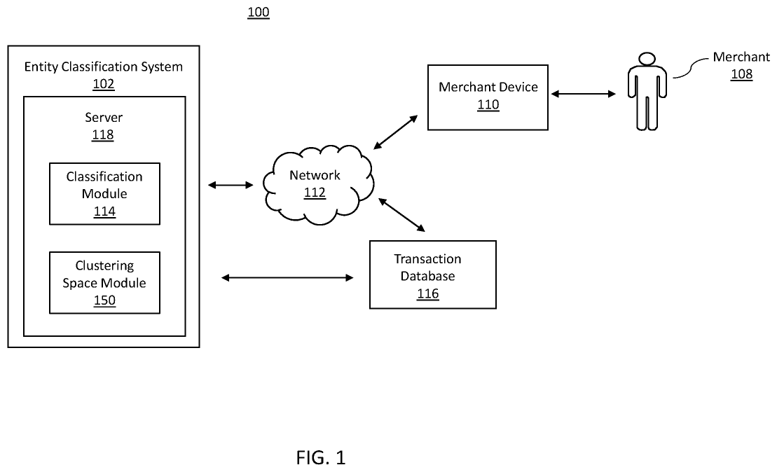

FIGS. 1 through 7 illustrate systems and methods for determining an entity-specific classification, such as, without limitation, a merchant risk classification, based on merchant product community and merchant supply chain modelling, in accordance with at least some embodiments of the present disclosure. In some embodiments, the entity-specific classification is determined using a set of data records such as, without limitation, a set of transaction records. The following embodiments provide technical solutions and technical improvements that overcome technical problems, drawbacks and/or deficiencies in at least one technical field involving the determination of risk associated with an entity on an electronic platform using machine learning. As explained in more detail below, the present disclosure provides a technically advantageous computer architecture that includes a unique machine learning model for risk classification. As a result, the instant disclosure presents advances both in the field of machine learning and in the field of risk classification.

Often, when attempting to determine if a merchant presents a high risk, such as a risk of conducting bad or fraudulent activities, there is very little available information regarding the merchant, especially on electronic platforms such as, for example, digital payment platforms. Occasionally, a business product category and a merchant category code (MCC) may be available. However, in some instances, the merchant's business is completely unknown. Embodiments of the present disclosure relate to systems and methods for determining a risk level of a merchant's business using the merchant's transaction records.

One aspect of the present disclosure includes a process for detecting a risky merchant by modelling two aspects of the merchant's business: a product community and a supply chain topology. In some embodiments, the product community and the supply chain topology are modelled using transaction records, including item descriptions, of the merchant. In some embodiments, a product community vector and a supply chain topology vector, generated based of the merchant's transaction records, may be combined and input into a machine learning model to generate a unified vector representing the merchant. In some embodiments, the product community vector and the supply chain topology vector may be combined by concatenation. In some embodiments, the product community vector and the supply chain topology vector may be combined via aggregation (i.e., summing up all elements among the two vectors in an element-wise manner). In some embodiments, the product community vector and the supply chain topology vector may be combined via projection (i.e., inputting the two vectors into a machine learning model or algorithm to generate a unified vector).

Referring now to the drawings, wherein like numerals refer to the same or similar features in the various views, FIG. 1 depicts an example computing system 100 for detecting merchant risk including an entity system, such as a financial service entity classification system 102, including a classification module 114 and a clustering space module 150 In some embodiments, the system 100 may enable a first entity, such as a merchant 108, to connect to the financial service entity classification system 102 through a merchant device 110, by way of a network 112. In some embodiments, the system 100 may also include a transaction database 116. In some embodiments, the merchant 108 may interact with the financial service entity classification system 102, which may include a server 118, with respect to transactions through the merchant device 110.

In general, the entity classification system 102 may determine a risk classification of one or more entities, including seller entities (e.g., merchant entities) based on the product community and/or modeled supply chain of that entity. Such a risk classification may find use in various transactional processes, such as determining whether or not to support transactions involving the entity, determining collateral or other requirements of executing or participating in transactions involving the entity, etc. Accordingly, based on a risk classification performed by the entity classification system 102, the entity classification system 102 (or a related computing system) may communicate with the entity to notify the entity of its risk classification, may notify the entity of collateral or other requirements for executing or participating in its transactions, may transmit a notification to a third party regarding the entity's risk classification (e.g., a buyer transacting with the classified entity, a payment card issuer or processor, etc.), or take some other automated action.

In some embodiments, the merchant device 110 may be one or more computing devices configured to execute software instructions for performing one or more operations consistent with the disclosed embodiments. In some embodiments, the merchant device 110 may be a mobile device (e.g., tablet, smartphone, etc.), a desktop computer, a laptop, a server, a wearable device (e.g., eyeglasses, a watch, etc.), and/or dedicated hardware device. In some embodiments, the merchant device 110 may include one or more processors configured to execute software instructions stored in memory, such as memory included in the merchant device 110. In some embodiments, the merchant device 110 may include software that, when executed by a processor, performs known Internet-related communication and content display processes. For instance, in some embodiments, the merchant device 110 may execute browser software that generates and displays interface screens including content on a display device included in, or connected to, the merchant device 110. The disclosed embodiments are not limited to any particular configuration of the merchant device 110. For instance, the merchant device 110 may be a mobile device that stores and executes mobile applications that provide financial-service-related functions offered by a financial service provider, such as an application associated with one or more user electronic payment accounts that a merchant holds with a financial service provider.

In some embodiments, the one or more processors may include one or more known processing devices, such as a microprocessor from the Core™, Pentium™ or Xeon™ family manufactured by Intel™, the Turion™ family manufactured by AMD™, or the “Ax” or “Sx” family manufactured by Apple™ for example. The disclosed embodiments are not limited to any type of processor otherwise configured to meet the computing demands of different components of the merchant device 110.

In some embodiments, the financial service entity classification system 102 may be a financial service entity, a technology company, an online payment provider or other type of service entity that generates, provides, manages, and/or maintains electronic payment accounts for one or more users (i.e., merchants, buyers, etc.). In some embodiments, electronic payment accounts may be associated with electronic accounts that may be used to perform electronic transactions, such as selling and purchasing goods and/or services online or in stores.

In some embodiments, the financial service entity classification system 102 includes infrastructure and components that are configured to generate and provide electronic payment accounts. In some embodiments, the financial service entity classification system 102 may also include infrastructure and components that are configured to manage transactions associated with an electronic payment account. In certain aspects, the financial service entity classification system 102 may provide a primary financial service to the merchant 108.

The network 112 may be any type of network configured to provide communications between components of the system 100. For example, the network 112 may be any type of network (including infrastructure) that provides communications, exchanges information, and/or facilitates the exchange of information, such as the Internet, a Local Area Network, near field communication (NFC), Bluetooth®, Wifi, or other suitable connection(s) that enables the sending and receiving of information between the components of the system 100. In other embodiments, one or more components of the system 100 may communicate directly through a dedicated communication link(s) (not shown), such as a link between the merchant 108 and the financial service entity classification system 102.

In some embodiments, the server 118 may include one or more processors, one or more memories, and one or more input/output (I/O) devices. According to some embodiments, server 118 may be an embedded system or similar computing device that generates, maintains, and provides web site(s) consistent with disclosed embodiments. In some embodiments, the server 118 may be standalone, or it may be part of a subsystem, which may be part of a larger system. For example, in some embodiments, the server 118 may represent distributed servers that are remotely located and communicate over a network (e.g., network 112) or a dedicated network, such as a LAN. In some embodiments, the server 118 may correspond to the financial service entity classification system 102.

In some embodiments, the processor of the server 118 may include one or more known processing devices, such as a microprocessor from the Core™, Pentium™ or Xeon™ family manufactured by Intel™, the Turion™ family manufactured by AMD™, or the “Ax” or “Sx” family manufactured by Apple™, for example. The disclosed embodiments are not limited to any type of processor(s) otherwise configured to meet the computing demands of different components of the server 118.

In some embodiments, the memory of the server may include one or more storage devices configured to store instructions used by the processor to perform functions related to disclosed embodiments. For example, the memory may be configured with one or more software instructions, such as program(s) that may perform one or more operations when executed by the processor. The disclosed embodiments are not limited to separate programs or computers configured to perform dedicated tasks. For example, the memory may include a single program that embodies the functions of the server 118, or the program could include multiple programs. Additionally, in some embodiments, the processor may execute one or more programs located remotely from the server 118. For example, the merchant device 110 may, via the server 118, access one or more remote programs that, when executed, perform functions related to certain disclosed embodiments. In some embodiments, the memory may also store data that reflects any type of information in any format that the server 118 may use in the system 100 to perform operations consistent with the disclosed embodiments.

In some embodiments, the server 118 may also be communicatively connected to one or more database(s), such as the transaction database 116. In some embodiments, the server 118 may be communicatively connected to the database(s) through the network 112. In some embodiments, the database may include one or more memory devices that store information and are accessed and/or managed through the server 118. By way of example, the database(s) by include Oracle™ databases, Sybase™ database, or other relational databases or non-relational databases, such as Hadoop sequences files, HBase, or Cassandra. The databases or other files may include, for example, data and information related to the source and destination of a network request, the data contained in the request, etc. The systems and methods of the disclosed embodiments, however, are not limited to separate databases. In some embodiments, the server 118 may include the databases. Alternatively, in some embodiments, the databases may be located remotely from the server 118. In some embodiments, the databases may include computing components (e.g., database management system, database server, etc.) configured to receive and process requests for data stored in memory devices of the database(s) and to provide data from the database.

As further described herein, in some embodiments, the server 118 may perform operations (or methods, functions, processes, etc.) that may require access to one or more peripherals and/or modules. In the example of FIG. 1, the server 118 includes the clustering space module 150 and the classification module 114.

In some embodiments, the clustering space module 150 may be implemented as an application (or set of instructions) or software/hardware combination configured to perform operations for determining a correlation between the merchant's product community and its supply chain topology. In some embodiments, the clustering space module 150 is configured to receive a combined (e.g., concatenated) vector encoding product community data and supply chain data of a merchant and to output a fine-tuned representation, encompassing the product community and supply chain data of the merchant, and classification of the merchant.

In some embodiments, the clustering space module 150 may be configured to utilize one or more machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an example neutral network technique may be one of, without limitation, feedforward neural network, radial basis function network, recurrent neural network, convolutional network (e.g., U-net) or other suitable network. In some embodiments and, optionally, in combination of any embodiment described above or below, an example implementation of a Neural Network may be executed as follows:
i) Define Neural Network architecture/model,
ii) Transfer the input data to the example neural network model,
iii) Train the example model incrementally,
iv) Determine the accuracy for a specific number of timesteps,
v) Apply the example trained model to process the newly-received input data,
vi) Optionally and in parallel, continue to train the example trained model with a predetermined periodicity.

In some embodiments, the clustering space module 150 may employ the Artificial Intelligence (AI)/machine learning techniques disclosed herein to generate a fine-tuned representation, or prediction, of the product community and supply chain of a merchant.

In some embodiments, the classification module 114 may be implemented as an application (or set of instructions) or software/hardware combination configured to perform operations for determining a risk classification of a merchant's business—i.e., if the merchant is a risky merchant or is not a risky merchant. In some embodiments, the classification module 114 is coupled to, and configured to communicate with the clustering space module 150. In some embodiments, the classification module 114 is configured to receive, from the clustering space module 150, the fine-tuned representation of the merchant's business. In some embodiments, the classification module 114 is configured to generate a classification of the business of the merchant.

In some embodiments, the classification module 114 may be configured to utilize one or more machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an example neutral network technique may be one of, without limitation, feedforward neural network, radial basis function network, recurrent neural network, convolutional network (e.g., U-net) or other suitable network. In some embodiments, the classification module 114 may employ the Artificial Intelligence (AI)/machine learning techniques to determine a risk classification of a merchant's business.

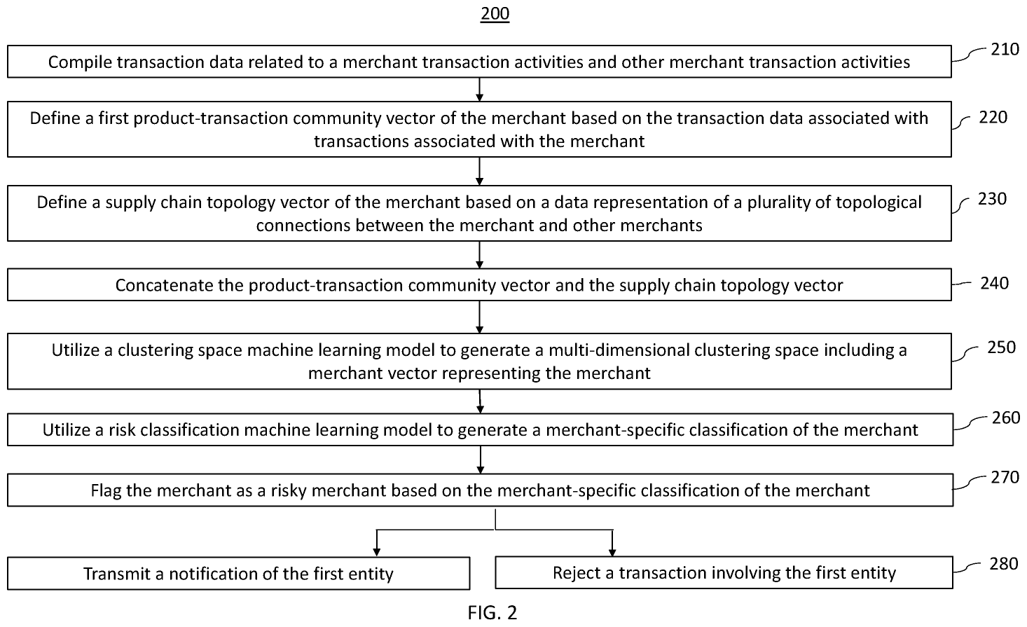

FIG. 2 is a process flow diagram illustration of an example of an illustrated computer-mediated process for classifying a risk associated with a merchant (e.g., a merchant 108) by modeling a product community and a supply chain topology of the merchant according to one or more embodiments of the present disclosure. The example computer-mediated process 200 may be executed by software, hardware, or a combination thereof. For example, process 200 may be performed by including one or more components described in the system 100 of FIG. 1 (e.g., server 118, merchant device 110 and transaction database 116).

In 210, the example computer-based system compiles transaction data within the transaction database 116 related to the merchant 108, about which a risk determination is to be made. In some embodiments, the risk level of the merchant 108 is determined at least in part using transaction data from the merchant's transaction records. In some embodiments, the transaction data may include a sender, a receiver and an amount of money that is being sent in the transaction. In some embodiments, the transaction data also includes a merchant item description. In some embodiments, the transaction database 116 may also include transaction data related to other merchants associated with the financial service entity classification system 102. For example, the system 100 may compile transaction records and data for merchants using a digital payment platform of a financial entity.

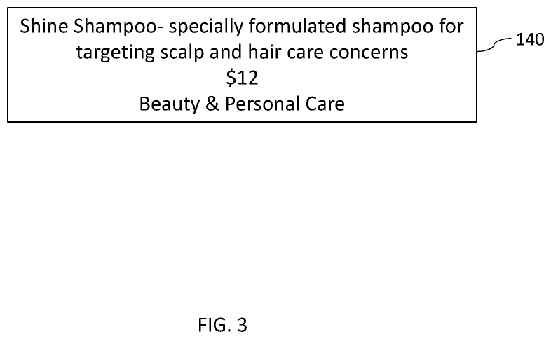

In some embodiments, a merchant item description may be a text that describes the items involved in a merchant's recent transactions. FIG. 3 depicts an example item description 140 from a transaction in which a merchant is selling shampoo. In some embodiments, an item description may be collected from transaction records of a merchant, which are available to a financial entity providing the digital payment platform. For example, in some embodiments, each transaction may be associated with an item description that describes the item involved in that transaction. In the example of FIG. 3, the item description 140 includes a name of the product, a brief description of the product, a price and a category of the product. In some embodiments, the item description may include at least one word, sentence or paragraph. In some embodiments, the merchant may have an identifier with the financial institution, which may be used to group all transactions within a specific period and collect an item description set.

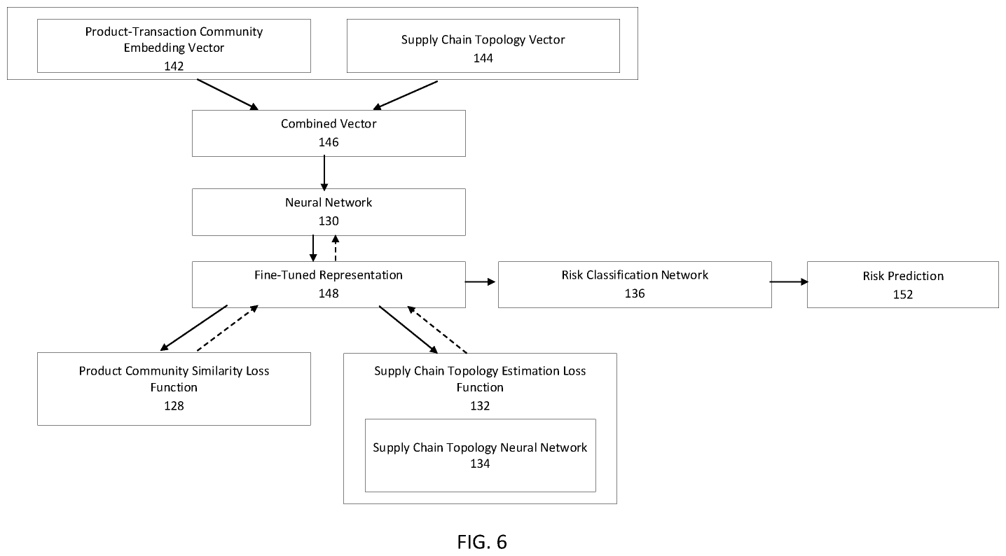

At 220, the system may leverage the data records associated with transactions associated with the merchant to model a product-transaction community of the merchant (e.g., to generate at product-transaction community embedding vector 142, as shown in FIG. 6). In some embodiments, an assumption may be made that a majority of the transactions completed by a merchant are correlated with the merchant's major business and the products that the merchant is selling. In some embodiments, the product-transaction community model may incorporate this assumption by removing item description text that is not correlated to the merchant's major business. In some embodiments, this removal can be performed by encoding each item description using word embedding. A clustering method may then be used to cluster the item description embeddings into majority clusters and filtering out the outlier item descriptions.

In some embodiments, after collecting a set of item descriptions for a merchant within the transaction database 116, transaction key words that are potentially correlated to a merchant's business may be extracted via tokenization, aggregation, as described in the exemplary process 400 below. In some embodiments, once the transaction key words are extracted, they may then be ranked and vectorized, as described in process 400, to build a business profile for each merchant.

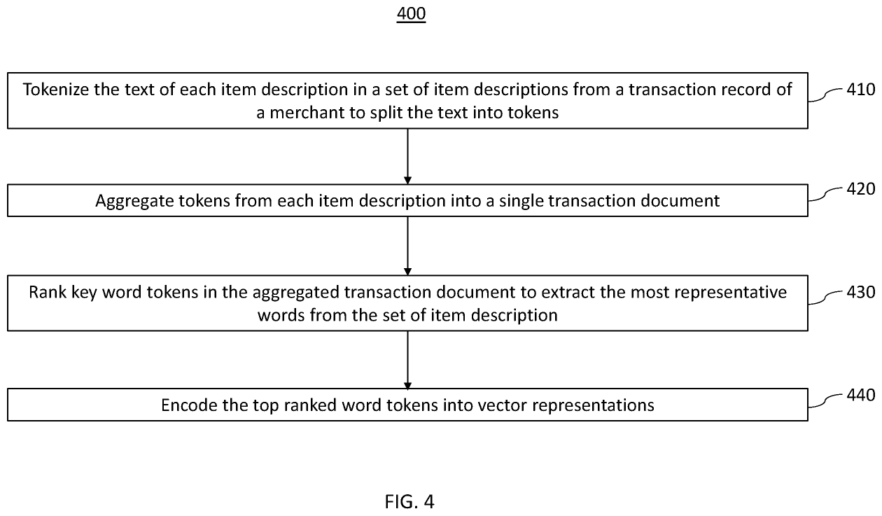

FIG. 4 is a process flow diagram illustration of an example of a process 400 for tokenization, aggregation, ranking and vectorization of words in a merchant's item description, according to one or more embodiments of the present disclosure.

At block 410, each item description from a transaction record of the merchant is tokenized to split the text into tokens, according to some embodiments of the present disclosure. In some embodiments, the tokenization process can be performed together with text cleaning. For example, in some embodiments, punctuation and stop words may be removed and the text may be normalized. As a result, in some embodiments, block 410 may include generating a respective sequence of word tokens for each item description.

At block 420, in some embodiments, the tokens from different item descriptions may then be aggregated into a single transaction document. In some embodiments, the aggregated transaction document contains all the word tokens from the different transactions of the merchant but disregards the order of the descriptions.

In some embodiments, at block 430, key words in the aggregated transaction document are then ranked to extract the most representative words from a set of item descriptions. In some embodiments, key words are words which appear in majority of the merchant's transaction records and are most informative for understanding the merchant's business. In some embodiments, key words may be identified using a TextRank algorithm. In some embodiments, a word co-occurrence graph G(T, E) may be built, where T represents the set of word tokens and E is the set of edges connecting co-occurrence word tokens. In some embodiments, in the word co-occurrence graph, a word token that appears in major transactions will have more connections to other word tokens. In some embodiments, the importance of each word token may be ranked based on a voting system. For example, in some embodiments, when a first word token is connected to a second word token, the first word token casts a “vote” to the second word token. The score associated with a word token is determined based on the votes that are cast for it, and the score of the word token casting these votes. In some embodiments, after all word tokens are ranked, they may be sorted according to the rank score and the top n word tokens may be selected to represent a seller's profile.

In some embodiments, at block 440, each of the top n word tokens may be encoded into separate respective vector representations. For example, in some embodiments, the top word tokens are encoded into word vectors using GloVe (Global Vectors for Word Representation). In some embodiments, all of the word vectors may then be combined into a single product information vector representing the item description data collected for the merchant.

In some embodiments, using the product information vector generated in the process 400, a transaction relationship between the merchant and other users (e.g., buyers or other merchants) may be determined by applying a graph convolutional network (GCN). In some embodiments, the GCN performs a convolution computation over the merchant's transaction relationships to build a graph representing the transactional relationship between the merchant and the other users. In some embodiments, the GCN is trained, using a loss function, to determine the product-transaction community of the merchant based on the product information vector and the transactional relationship graph. In some embodiments, the loss function is based on an unsupervised clustering model. In some embodiments, the loss function has the form given in equation (1) below:

L(eᵤ)=−log (σ(eᵤ^{T}eᵥ)−K·log (σ(−eᵤ^{T}eᵥ_{ₙ})) (Eq. 1)

In some embodiments, e represents a merchant (i.e., buyer or seller), K is the number of negative samples and T is the transpose of the GloVe vector. In some embodiments, once trained, the GCN receives as input a set of transaction relationships respective of a merchant and outputs a vector representation that encodes the merchant's transaction relationship (i.e., community) and product information—i.e., the merchant's product-transaction community embedding vector 142, as depicted in FIG. 6. In some embodiments, the merchant's product-transaction community may be formed due to: 1) other sellers in the community having a similar set of buyers, 2) other sellers in the community having heavily made transactions with each other, and 3) other sellers in the community having a similar seller product profile.

Referring again to FIG. 2, at block 230, the system may determine a supply chain of the merchant 108 based on a transaction relationship between the merchant 108 and other merchants (i.e., other buyers and sellers). In some embodiments, the supply chain is defined as a supply chain vector 144 of the merchant 108 based on a data representation of a plurality of topological connections between the merchant and the other merchants (i.e., other buyers and sellers). In some embodiments, the output from this step may be input into various downstream machine learning models and tasks. In some embodiments, the supply chain topology of the merchant 108 is an accurate indicator of a merchant's business model. For example, in some embodiments, a drop-shipper business tends to have long tail supply chain topology while a service provider business tends to have dense star topology. Some known supply chain topology strategies may be efficient, responsive, risk-hedging, and agile strategies. Different topologies may have different types of risks and different types of risks may be acceptable for different types of business. Thus, in some embodiments, understanding a supply chain topology of an entity (i.e., merchant) helps to understand the risks associated with that entity.

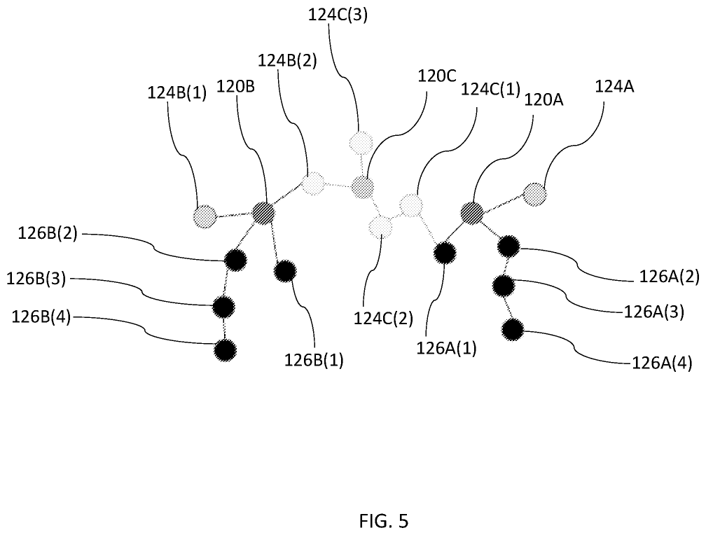

In some embodiments, the supply chain topology may be modeled for the merchant 108 based in part on the graph previously output by the GCN at block 220. As described above, the graph output by the GCN may represent a transaction relationship between the merchant, buyers and other merchants. For example, FIG. 5 depicts an example graph representing a supply chain of two merchants, Merchant A 120A and Merchant B 120B, according to embodiments of the present disclosure. The graph of FIG. 5 also depicts one buyer 124A of goods from the Merchant A 120A, two buyers 124B(1), 124B(2) of goods from the Merchant B 120B, four suppliers 126A(1)-126A(4) of goods to the Merchant A 120A, and four suppliers 126B(1)-126B(4) of goods to the Merchant B 120B in the supply chain of the Merchants 120A, 120B. The graph of FIG. 5 also depicts an additional Merchant C 120C connected to four buyers 124C(1), 124C(2), 124C(3) and 124B(2) of goods from Merchant C 120C. Two of the buyers 124C(1), 124C(2) connect the Merchant C 120C to the Merchant A 120A, via the supplier 126A(1) of Merchant A 120A, indicating that these buyers 124C(1), 124C(2) buy goods or services from the Merchant C 120C and the supplier 126A(1). Further, the buyer 124B(2) connects Merchant B 120B to Merchant C 120C, indicating that the buyer 124B(2) buys goods or services from the Merchant B and the Merchant C.

A shape of an entity's supply chain topology, or a portion of that topology, may be indicative of a risk associated with that entity. As a result, similar topology shapes associated with two merchants may indicate similar degrees of risk associated with those two merchants, as similar shapes may indicate similar business strategies. In the example of FIG. 5, an assumption may be made that Merchant A 120A and Merchant B 120B conduct a similar business because their graphical representations have similar shapes and scales. For example, in FIG. 5, each of the Merchant A 120A and Merchant B 120B have similar long tail supply chains having the same length (e.g., three suppliers 126A or 126B, respectively, in series). This long tail supply chain may indicate that each of the Merchant A 120A and the Merchant B 120B have drop-shipper businesses. In some embodiments, if a merchant includes a dense star topology, an assumption can be made that the merchant is a service provider. Thus, in some embodiments, an assumption can be made that if two merchants 120A, 120B are selling a similar product or are in a similar scale business, the two merchants will have a similar supply chain topology shape and scale.

In some embodiments, a network topology embedding model is applied to the transaction record of the merchant 108 to encode the supply chain topology for the merchant 108 into a form interpretable by a machine learning model, such as a vector. Network topology embedding is a concept of symmetry in which a network entity (i.e., the merchant 108) is identified according to the network structure and the entity's relationship to other entities (e.g., buyers and suppliers). In some embodiments, with transaction records, a network topology embedding algorithm may help to generate a supply chain encoding, or a supply chain embeddings vector, of the merchant 108. In some embodiments, the supply chain vector represents the merchant's business topology structure and its relationship to other entities, such as buyers, sellers and suppliers. In some embodiments, the network topology embedding algorithm may be struc2vec or role2vec, for example. In some embodiments, based on the merchant's transaction records, transaction relationships between the merchant 108 and the buyers, seller and suppliers, as well as the number of connections that belongs to the merchant 108 may be inferred.

As discussed above, in some embodiments, when modeling the supply chain topology of the merchant 108, an assumption may be made that two merchants have similar supply chain topology if they have similar number of connections and scale to other merchants, and their n-hop neighbors (for example, suppliers or buyers in the graph of FIG. 5 separated by n nodes in the graph) also have similar scale and connections. In some embodiments, the number of connections from an entity follows a Power-Law degree distribution. Thus, in some embodiments, a Power-Law degree distribution may be applied to the GCN graph of the merchant 108, its neighboring buyers and other merchants to extract the supply chain topology shape. In some embodiments, the density function of the Power-Law distribution is calculated using equations (2) and (3) below:

$$P ( x ) = {Cx}^{- a} \qquad ( Eq . 2 )$$

$$C = \frac{a - 1}{{x}_{min}^{- a + 1}} \qquad ( Eq . 3 )$$

where C is the normalizer and a is the parameter.

In some embodiments, the parameter a of the Power-Law probability density function may be estimated for each merchant by analyzing the degree of its neighbors. In some embodiments, an exponential binning method is used to estimate the parameters of the Power-Law probability density function. In some embodiments, a Power-Law python package may be used to estimate the parameters of the Power-Law probability density function. In some embodiments, two features, |neighbour| and a, are built for each merchant, where |neighbour| is the weighted number of transactions a merchant has and a is the previously-computed power law parameter. In some embodiments, propagation is performed to aggregate this information for n hop neighbors efficiently by equation (4), provided below:

SCF=D⁻¹AX (Eq. 4)

In some embodiments, SCF is the seller supply chain topology features with shape |e|*2, where |e| is the total number of merchants, A is the normalized adjacency matrix that maps transaction relationships between sellers and buyers and D⁻¹ is the inverse degree matrix for normalization. In some embodiments, the normalized adjacency matrix A represents the connectivity and relationship between the merchant 108 and other merchants (i.e., sellers and buyers). For example, in some embodiments, the adjacency matrix is N×N, where N is the number of merchants. In some embodiments, SCF ensures that merchants with similar n hop neighbor distributions have similar values. In other words, merchants with similar supply chain topology may have similar feature values. In some embodiments, after n iterations, a supply chain representation may be generated as {iter1, iter2 . . . itern}, where each iteration may contain information about the scale and supply chain topology structure between the merchant and its suppliers and/or buyers within an n−hop random walk length. For example, in some embodiments, iter2 may contain scale and supply chain topology structure for the merchant 108 and its suppliers/buyers from 1 to 2 hops. Thus, in some embodiments, the supply chain topology of a merchant 108 may be effectively estimated in a vector using the described encoding and merchants with similar scale supply chain topology will have similar representations.

In some embodiments, X in equation (4) is a matrix encompassing each merchant and its related features. For example, with reference back to FIG. 5, in some embodiments, a vector may be generated having two columns each for Merchant A 120A and Merchant B 120B. In some embodiments, a first column of the vector is the number of neighbors merchant A 120 has in the graph, in this case three neighbors. In some embodiments, the second column is the value A that is computed for the Power-Law distribution of Merchant A. In some embodiments, a matrix X is then generated encompassing each of the merchant vectors, where each row is a different merchant. For example, in some embodiments, the matrix X may be E times two, where E is the number of merchants in the matrix and two is the number of columns per merchant (i.e., one column for the number of neighbors and one column for the Power-Law distribution of each merchant). Accordingly, the matrix X has a form that is easily input in the propagation equation above.

In some embodiments, by multiplying the matrix X with the adjacency matrix A and the inverse degree matrix D⁻¹ for normalization, an initial two-column vector, SCF, is propagated representing the neighborhood of the merchant (i.e., the neighboring nodes of Merchant A in FIG. 5). The initial SCF vector may then be used to propagate multiple further SCF vector iterations for multiple hops of the merchant neighborhood. For example, the initial SCF vector may be used as the X value of the propagation equation for a second SCF iteration. Similarly, the second iteration SCF vector may be used as the X value of the propagation equation for a third SCF iteration, and so on for n iterations. In some embodiments, the resultant vectors of each iteration represent the supply chain topology shape for each merchant within the neighborhood (e.g., the supply chain topology vector 144 of FIG. 6).

At block 240, the product-transaction community embedding vector 142 and the supply chain topology vector 144 may be combined into a single combined vector 146, depicted in FIG. 6. In some embodiments, the product-transaction community embedding vector 142 and the supply chain topology vector 144 may be concatenated into a single vector. In some embodiments, the combined vector 146 is formatted for input into and processing by the downstream machine learning models, as will be discussed in further detail below.

At block 250, machine learning may be used to generate a unified, fine-tuned representation 148 (FIG. 6) of the supply chain topology data and the product-transaction community data of the merchant. For example, in some embodiments, the clustering space module 1150 may train a machine learning model to generate a fine-tuned representation of the merchant 108 (e.g., a vector representation). In some embodiments, the clustering space module 150 may also predict a risk level for the merchant according to the fine-tuned representation. In some embodiments, the machine learning model is a multi-class clustering neural network 130, as depicted in FIG. 6. In some embodiments, the neural network 130 generates a multi-dimensional (e.g., l-dimensional) vector representing the merchant 108 within a multi-dimensional (e.g., l-dimensional) clustering space. In some embodiments, the neural network 130 may be trained using at least one loss function.

In some embodiments, a first loss function (e.g., a product community similarity loss function 128), uses supervised learning to train the neural network 130 to perform a community classification based on an assumption that merchants from the same product categories are part of the same or similar communities. That is, in some embodiments, the product community similarity loss function 128 utilizes business classification labels of a merchant to determine which community a merchant is in. In some embodiments, a business classification label may be a product or service category such as, for example, health and beauty, medical, consumer goods, etc. In some embodiments, the business classification label of a merchant can be retrieved from the merchant's transaction data within the transaction database 116. In some embodiments, a training data set for the product community similarity loss function 128 may be a set of merchants and a set of classification labels associated with the set of merchants. In some embodiments, the set of merchants and the set of classification labels may be stored in the transaction database 116. Thus, in some embodiments, training the neural network 112 on business classification labels may allow the unified representation to be fine-tuned in an explicit way to identify the difference between different business classifications. Furthermore, in some embodiments, the training the neural network 130 on business classification labels may improve the supply chain modeling by learning from the existing merchant classification labels. In some embodiments, the following objective function, provided as equation (5) and equation (6) below, may be used to train the neural network 130:

y=SoftMax(f(x)) (Eq. 5)

L=−Σᵢ^{C}ŷᵢ log (yᵢ) (Eq. 6)

In some embodiments, f(x) may be the unified representation learned from the neural network 130, C may be the total number of business classification labels and ŷ may be the expected business classification labels.

In some embodiments, a joint training process utilizes a second loss function (e.g., a supply chain topology estimation loss function 132), in conjunction with the product community similarity loss function 128 to encourage merchants within similar product communities or who have similar scale supply chain topology to have similar fine-tune representations, as depicted in FIG. 6. In some embodiments, the joint learning process uses unsupervised learning to train the neural network 130. In some embodiments, the supply chain topology estimation loss function 132 works under the assumption that if two merchants have similar supply chain topologies, then the merchants should have a similar fine-tuned representation. In some embodiments, an objective function may be used to strengthen the relationship between both the product-transaction community of a merchant and supply chain topology of a merchant. In some embodiments, the objective function may emphasize that merchants who belong to similar businesses classification labels may be members of the same product community and may be regulated by expected supply chain topology detected by the supply chain topology method provided above. In some embodiments, the overall objective function is formulated as equation (7), below:

$${L}_{N} = \frac{1}{N} {\sum }_{i = 1}^{T} log σ ( {e}_{u}^{T} {e}_{v} ) + \frac{1}{N} {\sum }_{i = 1}^{kT} log σ ( - {e}_{u}^{T} {e}_{{v}^{′}} ) + λ {‖ {s}_{u} - {\hat{s}}_{u} ‖}_{2}^{2} \qquad ( Eq . 7 )$$

In some embodiments, eᵤ is the fine-tuned representation of a merchant, eᵥ is the representation of co-occurring sellers/buyers/suppliers near eᵤ within a fixed length random walk, s is the predicted supply chain topology and ŝ is the expected supply chain topology. In this case, both relationships enhance each other to fine-tune the merchant representation. In some embodiments, the supply chain topology estimation loss function 132 and the product community similarity loss function 128 may optimize the product community prediction and a supply chain topology prediction for the merchant 108.

In some embodiments, the supply chain topology estimation loss function 132 is used in connection with a supply chain topology neural network 134, as depicted in FIG. 6, that is configured to enable the neural network 130 to more accurately predict the supply chain topology of a merchant. In some embodiments, the supply chain topology neural network may be optional.

At block 260, a risk classification network 136 may be applied to the merchant representation to predict a risk classification of the merchant 108. In some embodiments, the risk classification network 136 may be optional. In some embodiments, the risk classification network 136 may predict one of two classifications: i) a risky merchant or ii) a safe merchant. In some embodiments, the risk classification network 136 may output a numerical or other indicator of the degree of risk of the merchant. In some embodiments, the risk classification network may be trained in an end-to-end training process along with the rest of the architecture of FIG. 6. In some embodiments, the risk classification network 136 is naturally embedded into the joint-learning architecture depicted in FIG. 6. In some embodiments, an alternative individual classifier such as, for example, XGBoost, can be used to detect a risky seller based on the fine-tuned representation. Thus, as a result of step 260, the risk classification network 136 outputs a risk prediction 152 as to whether merchant 108 is a risky merchant or not.

At block 270, the system 100 may flag the merchant 108 as a risky merchant, based on a classification of the merchant 108 as a risky merchant.

At block 280, as a result of the merchant 108 being flagged as a risky merchant, the system 100 may take one of many actions. For example, in some embodiments, the system 100 may transmit a notification of the risky merchant determination to the merchant and the financial service entity. In some embodiments, the system 100 may reject a new transaction involving the merchant 108. In some embodiments, the system 100 may remove the merchant 108 from the electronic payment platform. In some embodiments, the system 100 may prevent the merchant 108 from engaging in certain activities. For example, in some embodiments, the merchant 108 may be restricted to only engaging in transactions in which the merchant 108 is a buyer and prevented from engaging in transactions in which the merchant 108 is a seller. In some embodiments, other restrictions may be applied to the merchant 108 or an account of the merchant 108. For example, in some embodiments, a merchant 108 may only be permitted to engage in transactions below a certain monetary threshold, or the merchant 108 may only be permitted to engage in transaction that are first verified by the financial service entity, etc.

Although the flowchart shows a specific order of execution, it is understood that the order of execution may differ from that which is depicted. For example, the order of execution of two or more boxes may be scrambled relative to the order shown. Also, two or more boxes shown in succession may be executed concurrently or with partial concurrence. Further, in some embodiments, one or more of the boxes may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

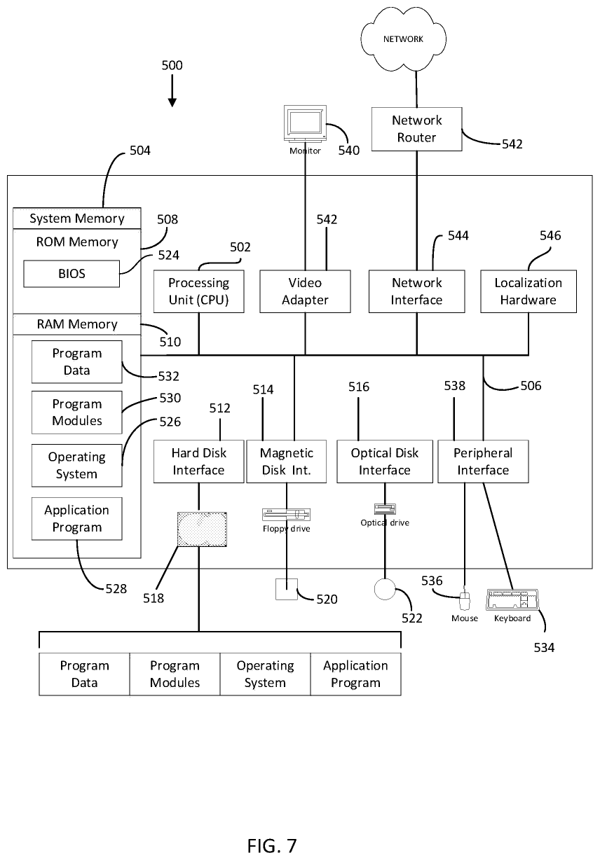

FIG. 7 is a block diagram of an example computing system, such as a desktop computer, laptop, smartphone, tablet, or any other such device having the ability to execute instructions, such as those stored within a non-transient, computer-readable medium. Furthermore, while described and illustrated in the context of a single computing system 500, those skilled in the art will also appreciate that the various tasks described hereinafter may be practiced in a distributed environment having multiple computing systems 500 linked via a local or wide-area network in which the executable instructions may be associated with and/or executed by one or more of multiple computing systems 500.

In its most basic configuration, computing system environment 500 typically includes at least one processing unit 502 and at least one memory 504, which may be linked via a bus 506. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard drive 518, and/or peripheral memory devices may be used to store computer executable instructions comprising an operating system 526, one or more applications programs 528, other program modules 530, and/or program data 532. Still further, computer-executable instructions may be downloaded to the computing environment 500 as needed, for example, via a network connection. The applications programs 528 may include, for example, a browser, including a particular browser application and version, which browser application and version may be relevant to determinations of correspondence between communications and user URL requests, as described herein. Similarly, the operating system 526 and its version may be relevant to determinations of correspondence between communications and user URL requests, as described herein.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus 506 via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 542, that is responsible for network routing. Communications with the network router 542 may be performed via a network interface component 544. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 546 for determining a location of the computing system environment 500. In embodiments, the localization hardware 546 may include, for example only, a GPS antenna, an RFID chip or reader, a WiFi antenna, or other computing hardware that may be used to capture or transmit signals that may be used to determine the location of the computing system environment 500. Data from the localization hardware 546 may be included in a callback request or other user computing device metadata in the methods of this disclosure.

The computing system, or one or more portions thereof, may embody a merchant device 110, in some embodiments. Additionally or alternatively, some components of the computing system 500 may embody the entity classification system 102. For example, the functional modules 114, 150 may be embodied as program modules 530.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

1. A method comprising:
defining, by a processor, a first data vector of a first entity based on a set of data records associated with representative activities of the first entity,
wherein the set of data records comprise:
product data associated with the first entity, and
at least one relationship data representing an activities relationship between the first entity and a plurality of second entities,
wherein the first data vector encodes the product data and the at least one relationship data of the first entity;
defining, by the processor, a second data vector of the first entity based on a data representation of a plurality of topological connections between the plurality of second entities and the first entity,
wherein the plurality of topological connections define a shape that represents a plurality of relationships between the first entity and at least one of the plurality of second entities within a supply chain of the first entity;
utilizing, by the processor, a clustering space machine learning model to generate an entity vector representing the first entity based on the first data vector and the second data vector; and
utilizing, by the processor, a classification machine learning model to generate an entity-specific classification of the first entity based on the entity vector representing the first entity.

2. The method of claim 1, further comprising:
training, by a processor, the clustering space machine learning model to generate the entity vector based at least in part on a training data set comprising a set of entities and a set of classification labels associated with the set of entities.

3. The method of claim 1, further comprising:
training, by the processor, the clustering space machine learning model to generate a multi-dimensional clustering space comprising the entity vector by:
defining a training data set comprising a plurality of training entities, each training entity having a first data vector based on a set of data records associated with the training entity and a second data vector based on a data representation of a plurality of topological connections between a plurality of second training entities and the training entity;
inputting, by the processor, the training data set into the machine learning model; and
minimizing, by the processor, a loss function, the loss function comprising:
a mathematical combination of a first data vector of a first training entity and a first data vector of a second training entity; and
a mathematical combination of the second data vector of the first training entity and a predicted second data vector of the first training entity.

4. The method of claim 1, wherein:
the product data comprises at least one product description,
wherein the at least one product description is tokenized and aggregated to form at least one word vector,
wherein the at least one word vector is combined to generate a product information vector.

5. The method of claim 1, wherein:
the first entity is a merchant;
the plurality of second entities comprises a plurality of other merchants, buyers or a combination thereof,
wherein the data representation of the plurality of topological connections between the merchant and the plurality of other merchants, buyers or a combination thereof is extracted using a Power-Law degree distribution.

6. The method of claim 1, further comprising generating the first data vector of the first entity by:
tokenizing a set of item descriptions associated with the first entity to generate a sequence of word tokens;
aggregating the sequence of word tokens into a single activity document;
ranking the word tokens to extract a set of representative words from the set of item descriptions.

7. The method of claim 1, further comprising concatenating, by the processor, the first data vector of the first entity and the second data vector of the first entity to generate a concatenated data vector of the first entity.

8. The method of claim 1, further comprising, according to the entity-specific classification of the first entity, one or more of:
transmitting, by the processor, a notification to the first entity, wherein the notification is related to the entity-specific classification; or
rejecting, by the processor, a transaction involving the first entity.

9. The method of claim 1, further comprising, according to the entity-specific classification of the first entity, one or more of:
removing, by the processor, the first entity from an activity platform, or
preventing, by the processor, the first entity from engaging in future activities.

10. A system for configuring a search engine to classify a search query, the system comprising:
a processor; and
a non-transitory computer-readable medium having stored thereon instructions that are executable by the processor to cause the system to perform operations comprising:
defining a first data vector of a first entity based on a set of data records associated with representative activities of first users associated with the first entity,
wherein the set of data records comprises:
product data associated with the first entity, and
at least one relationship data representing an activities relationship between the first entity and a plurality of second entities,
wherein the first data vector encodes the product data and the at least one relationship data of the first entity;
defining a second data vector of the first entity based on a data representation of a plurality of topological connections between the plurality of second entities and the first entity,
wherein the plurality of topological connections are indicative of a shape of a plurality of relationships between the first entity and at least one of the plurality of second entities within a supply chain of the first entity;
utilizing a clustering space machine learning model to generate a multi-dimensional clustering space comprising an entity vector representing the first entity based on the first data vector and the second data vector; and
generating an entity-specific classification of the first entity based on the multi-dimensional clustering space.

11. The system of claim 10, wherein the non-transitory computer-readable medium stores further instructions that, when executed by the processor, cause the system to perform further operations comprising:
training the clustering space machine learning model to generate the multi-dimensional clustering space based at least in part on a training data set comprising a set of entities and a set of classification labels associated with the set of entities.

12. The system of claim 10, wherein the non-transitory computer-readable medium stores further instructions that, when executed by the processor, cause the system to perform further operations comprising:
train the clustering space machine learning model to generate the multi-dimensional clustering space by:
defining a training data set comprising a plurality of training entities, each training entity having a first data vector based on a set of data records associated with the training entity and a second data vector based on a data representation of a plurality of topological connections between a plurality of second training entities and the training entity;
input the training data set into the machine learning model; and
minimize a loss function, the loss function comprising:
a mathematical combination of a first data vector of a first training entity and a first data vector of a second training entity; and
a mathematical combination of the second data vector of the first training entity and a predicted second data vector of the first training entity.

13. The system of claim 10, wherein:
the product data comprises at least one product description,
wherein the at least one product description is tokenized and aggregated to form at least one word vector,
wherein the at least one word vector is concatenated to generate a product information vector.

14. The system of claim 10, wherein:
the first entity is a merchant; and
the plurality of second entities comprises a plurality of other merchants, buyers or a combination thereof,
wherein the data representation of the plurality of topological connections between the merchant and the plurality of other merchants, buyers or a combination thereof is extracted using a Power-Law degree distribution.

15. The system of claim 10, wherein the non-transitory computer-readable medium stores further instructions that, when executed by the processor, cause the processor to:
generate the first data vector of the first entity by:
tokenizing a set of item descriptions associated with the first entity to generate a sequence of word tokens;
aggregating the sequence of word tokens into a single activity document; and
ranking the word tokens to extract a set of representative words from the set of item descriptions.

16. The system of claim 10, wherein the non-transitory computer-readable medium stores further instructions that, when executed by the processor, cause the system to perform further operations comprising, according to the entity-specific classification of the first entity, one or more of:
transmit a notification to the first entity, wherein the notification is related to the entity-specific classification;
reject a transaction involving the first entity;
remove the first entity from an activity platform, or
prevent the first entity from engaging in future activities.

17. A method comprising:
defining, by a processor, a first data vector of a first entity based on a set of data records associated with representative activities of the first entity,
wherein the set of data records comprise:
product data associated with the first entity, and
at least one relationship data representing an activities relationship between the first entity and a plurality of second entities,
wherein the first data vector encodes the product data and the at least one relationship data of the first entity;
defining, by the processor, a second data vector of the first entity based on a data representation of a plurality of topological connections between a plurality of second entities and the first entity,
wherein the plurality of topological connections represents a shape indicative of a plurality of relationships between the first entity and at least one of the plurality of second entities within a supply chain of the first entity;
generating a prediction that the first entity exhibits a characteristic by inputting the first data vector and the second data vector into a multi-dimensional clustering space machine learning model;
wherein the prediction is generated based at least in part on a determination that the shape represented by the plurality of topological connections is similar to a reference shape represented by a plurality of topological connections of one of the plurality of second entities that has been identified as having the characteristic.

18. The method of claim 17, further comprising:
training, by a processor, the clustering space machine learning model to generate the multi-dimensional clustering space based at least in part on a training data set comprising a set of entities and a set of classification labels associated with the set of entities.

19. The method of claim 17, further comprising:
training, by the processor, the clustering space machine learning model to generate the multi-dimensional clustering space by:
defining a training data set comprising a plurality of training entities, each training entity having a first data vector based on a set of data records comprising the training entity and a second data vector based on a data representation of a plurality of topological connections between a plurality of second entities and the training entity;
inputting, by the processor, the training data set into the machine learning model; and
minimizing, by the processor, a loss function, the loss function comprising:
a mathematical combination of a first data vector of a first training entity and a first data vector of a second training entity; and
a mathematical combination of the second data vector of the first training entity and a predicted second data vector of the first training entity.

20. The method of claim 18, further comprising, according to an entity-specific classification of the first entity, one or more of:
transmitting a notification to the first entity, wherein the notification is related to the entity-specific classification;
rejecting a transaction involving the first entity;
removing the first entity from an activity platform, or
preventing the first entity from engaging in future activities.
